(19) United States
(12) Patent Application Publication
(10) Pub. No.: US 2025/0211389 A1
(43) Pub. Date: Jun. 26, 2025

(54) TRANSMISSION OF SOUNDING REFERENCE SIGNALS USING A PLURALITY OF PORTS OF A USER EQUIPMENT

(71) Applicants: CENTRE OF EXCELLENCE IN WIRELESS TECHNOLOGY, Chennai, Tamil Nadu (IN); INDIAN INSTITUTE OF TECHNOLOGY MADRAS (IIT MADRAS), Chennai, Tamil Nadu (IN)

(72) Inventors: Pardhasarathy JYOTHI, Chennai, Tamil Nadu (IN); Dhivagar BASKARAN, Chennai, Tamil Nadu (IN); Jeniston Deviraj Klutto MILLETH, Chennai, Tamil Nadu (IN); Bhaskar RAMAMURTHI, Chennai, Tamil Nadu (IN)

(73) Assignees: CENTRE OF EXCELLENCE IN WIRELESS TECHNOLOGY, Chennai, Tamil Nadu (IN); INDIAN INSTITUTE OF TECHNOLOGY MADRAS (IIT MADRAS), Chennai, Tamil Nadu (IN)

(21) Appl. No.: 18/844,702

(22) PCT Filed: Mar. 13, 2023
(86) PCT No.: PCT/IN2023/050234

§ 371 Date: Sep. 6, 2024

(30) Foreign Application Priority Data
Mar. 16, 2022 (IN) 202241014298

(51) Int. Cl. H04L 5/00; H04J 13/00; H04L 27/26

(52) U.S. Cl. CPC H04L 5/0051; H04J 13/0062; H04L 27/2605

(57) ABSTRACT

A method of communication in a cellular network is described. The method comprises determining Sounding Reference Signal (SRS) antenna ports of a user equipment configured for transmission of SRSs to a base station. The SRS antenna ports are divided into a first group of antenna ports and a second group of antenna ports when a number of antenna ports is greater than a predefined number of antenna ports. Orthogonality is maintained between the SRSs of the first group of antenna ports and the SRSs of the second group of antenna ports using one of a group index, a cyclic shift, time division multiplexing, and frequency division multiplexing. A first set of SRSs are transmitted over the first group of antenna ports and a second set of SRSs are transmitted over the second group on antenna ports.

### FIELD OF THE INVENTION

The present invention relates to communication between a base station and a user equipment, and more particularly to transmission of sounding reference signals to a base station using a plurality of ports of a user equipment.

### BACKGROUND OF THE INVENTION

Wireless communication systems are widely deployed to provide various telecommunication services such as telephony, video, data, messaging, and broadcasting. Typical wireless communication systems may employ multiple-access techniques capable of supporting communication with multiple users by sharing the available system resources (e.g., bandwidth and transmit power). Examples of such multiple access techniques include: Long Term Evolution (LTE) systems, Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier Frequency Division Multiple Access (SC-FDMA) systems, and Time Division Synchronous Code Division Multiple Access (TD-SCDMA) systems.

New Radio (NR) technology is emerging as a next generation 5G standard, multiple features are being enhanced from a base NR version, to support wide range of devices. In NR technology, a User Equipment (UE) transmits a Sounding Reference Signal (SRS) to a Base Station (BS) for determining an uplink channel state information. Conventional NR technology provides techniques for transmitting SRS to a BS using a fixed number of SRS antenna ports (typically 4 antenna ports) of a UE. With increase in advancement of technology, UEs with no power or complexity constraints, such as customer premises equipment (such as Telephone handsets, cable TV set-top boxes, and Digital Subscriber Line (DSL) routers) and vehicular devices (such as wireless devices associated with autonomous cars) may utilize large number of antennas (more than 4 antenna ports) for transmission of SRS to a BS. Conventional NR technology does not provide a technique for transmission of SRS to a BS using more than 4 antenna ports of a UE.

Thus, there is a need of a method for transmission of SRS to a BS using more than four SRS antenna ports, which addresses the above-mentioned shortcomings associated with conventional technique of transmission of SRS.

### OBJECTS OF THE INVENTION

A general objective of the present invention is to provide a method for transmission of Sounding Reference Signal (SRS) using a plurality of SRS antenna ports of a User Equipment (UE).

Another objective of the present invention is to provide a method for transmission of SRS for a UE with no power or complexity constraints.

### SUMMARY OF THE INVENTION

The summary is provided to introduce aspects related to transmission of sounding reference signals using a plurality of ports of a user equipment, and the aspects are further described below in the detailed description. This summary is not intended to identify essential features of the claimed subject matter nor is it intended for use in determining or limiting the scope of the claimed subject matter.

The present invention relates to a method for communication between a User Equipment (UE) and a Base Station (BS). The method may comprise determining Sounding Reference Signal (SRS) antenna ports of the UE configured for transmission of SRSs to the BS. The sounding reference signal (SRS) antenna ports are divided into a first group of antenna ports and a second group of antenna ports when a number of antenna ports is greater than a predefined number of antenna ports. A first set of parameters associated with the first group of antenna ports and a second set of parameters associated with the second group of antenna ports may be determined for generation of the SRSs. Orthogonality may be maintained between the SRSs of the first group of antenna ports and the SRSs of the second group of antenna ports using one of a group index, a cyclic shift, time division multiplexing, and frequency division multiplexing. A first set of SRSs may be generated using the first set of parameters and a second set of sounding reference signals may be generated using the second set of parameters. Further, the first set of SRSs may be transmitted over the first group of antenna ports and the second set of SRSs may be transmitted over the second group on antenna ports to the BS.

In an aspect, the first set of parameters and the second set of parameters may comprise group index, sequence index, cyclic shift of Zadoff-Chu (ZC) sequences, OFDM symbol, slot index, and a transmission comb.

In an aspect, the first set of parameters may be determined using a first group index and the second set of parameters are determined using a second group index.

In as aspect, the second group index may be determined by addition of the first group index and a group shift provided by the BS.

In an aspect, the first set of parameters may be determined using a first set of cyclic shifts and the second set of parameters are determined using a second set of cyclic shifts.

In an aspect, the second set of cyclic shifts may be determined using the first set of cyclic shifts and an offset value of cyclic shift provided by the BS.

In an aspect, the first set of parameters may be determined using a first set of OFDM symbols and the second set of parameters are determined using a second set of OFDM symbols.

In an aspect, the first set of parameters may be determined using a first time slot and the second set of parameters are determined using a second time slot.

In an aspect, the second time slot may be determined by addition of the first time slot and a slot offset provided by the BS.

In an aspect, the first set of parameters may be determined using a first transmission comb and the second set of parameters are determined using a second transmission comb.

Other aspects and advantages of the invention will become apparent from the following description, taken in conjunction with the accompanying drawings, illustrating by way of example the principles of the invention.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an architecture of a cellular network utilizing a User Equipment (UE) and a Base Station (BS), in accordance with an embodiment of the present invention.

FIG. 2 illustrates a flow chart of a method for transmission of Sounding Reference Signal (SRS) to a BS using a group index, in accordance with an embodiment of the present invention.

FIG. 3 illustrates a flow chart of a first method for transmission of SRS to a BS using a cyclic shift, in accordance with an embodiment of the present invention.

FIG. 4 illustrates a flow chart of a second method for transmission of SRS to a BS using different cyclic shift, in accordance with an embodiment of the present invention.

FIG. 5 illustrates a flow chart of a method for transmission of SRS to a BS using symbols, in accordance with an embodiment of the present invention.

FIG. 6 illustrates a flow chart of a method for transmission of SRS to a BS using time slots, in accordance with an embodiment of the present invention.

FIG. 7 illustrates a flow chart of a method for transmission of SRS to a BS using frequency division multiplexing, in accordance with an embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

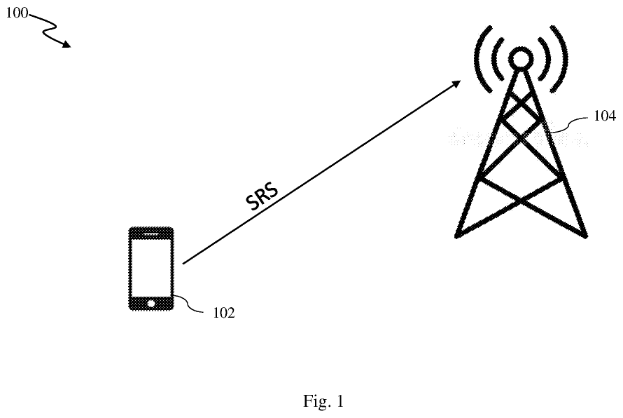

FIG. 1 illustrates an architecture of a cellular network 100 utilizing a User Equipment (UE) 102 and a Base Station (BS) 104, in accordance with an embodiment of the present invention. The UE 102 may transmit Sounding Reference Signal (SRS) to the BS 104 for estimation of an uplink channel state information. The uplink channel state information may be estimated at the BS 104. The SRS may be generated at the UE 102 by defining a set of parameters such as a cyclic shift (a) of a base sequence (r). In an implementation, the base sequence may be defined as a Zadoff-Chu (ZC) sequence. The base sequence (r) is a primary sequence in generation of a SRS sequence for all antenna ports of the UE 102. The base sequence (r) is represented in the following equation (1):

$${r}_{u , v}^{( α )} = {e}^{j α n} {r}_{( u , v )} ( n ) \qquad ( 1 )$$

The equation (1) contains following variables:
n=0, . . . , M_{sc}^{RS}−1, where M_{sc}^{RS} is the length of the base sequence;
u=0, . . . ,29 is a group number of the base sequence; and
v=0.1 is the sequence number within a group.

If an SRS resource is configured with Nₐₚ^{SRS} ports p for transmission, the UE 102 may generate Nₐₚ^{SRS} ZC-sequences of same length but with different cyclic shifts. Further, orthogonality across the antenna ports may be maintained during channel estimation. The UE 102 may further generate a ZC-sequence for an antenna port using a group index of the base sequence and a cyclic shift used to generate the ZC-sequence. The group index and the cyclic shift are calculated using the equations (2), (3), and (4),

$$u = ( {f}_{g h} ( {n}_{s , f}^{μ} , {l}^{′} ) + {n}_{ID}^{SRS} ) mod 30 \qquad ( 2 )$$

$${α}_{i} = 2 π \frac{{n}_{SRS}^{cs , i}}{{n}_{SRS}^{cs , max}} \qquad ( 3 )$$

$${n}_{SRS}^{cs , i} = ( {n}_{SRS}^{c s} + \frac{{n}_{SRS}^{cs , max} ( {p}_{i} - 1000 )}{{N}_{ap}^{SRS}} ) mod {n}_{SRS}^{cs , max} \qquad ( 4 )$$

The equations (1), (2), and (3) contains following variables:
u is the group index of the sequence;
aᵢ is the cyclic shift of the sequence for SRS port pᵢ;
n_{ID}^{SRS}, n_{SRS}^{cs,max}, N_{SRs}^{CS}, and Nₐₚ^{SRS} are configured for the UE 102 by the BS 104 using higher layer signaling;
f_{gh} is a function used for group and sequence hopping;
n_{s,f}^{μ} is slot number within a frame for subcarrier spacing configuration u; and
l′∈{0,1, . . . , N_{symb}^{SRS}−1} where N_{symb}^{SRS} is the number of consecutive OFDM symbols used to transmit SRS resource.

Present invention describes different methods for the UE 102 to support a large number the antenna ports, such as more than 4 antenna ports. If a UE is configured with Nₐₚ^{SRS} antenna ports, then the antenna ports may be divided into a first group of antenna ports and a second group of antenna ports. The first group of antenna ports may comprise of first N̅ₐ̅ₚ̅^̅{̅S̅R̅S̅}̅ antenna ports from the Nₐₚ^{SRS} antenna ports arranged in an ascending order, such as {0,1, . . . . N̅ₐ̅ₚ̅^̅{̅S̅R̅S̅}̅ −1}. The second group of antenna ports may comprise of the last (Nₐₚ^{SRS}−N̅ₐ̅ₚ̅^̅{̅S̅R̅S̅}̅) antenna ports from the set of NRS antenna ports arranged in the ascending order, such as {N̅ₐ̅ₚ̅^̅{̅S̅R̅S̅}̅, N̅ₐ̅ₚ̅^̅{̅S̅R̅S̅}̅+1, . . . . Nₐₚ^{SRS}−1}.

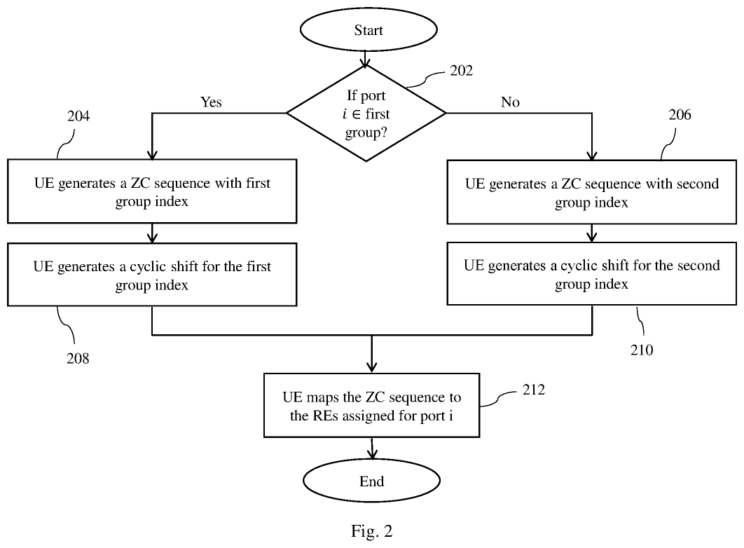

FIG. 2 illustrates a flow chart of a method for transmission of SRS to the BS 104 using a group index, in accordance with an embodiment of the present invention. The UE 102 may check whether an antenna port belongs to the first group of antenna ports or not, at step 202. The UE 102 may determine a first group index (u1) of the ZC sequence for the first group of antenna ports based on slot and symbol index, at step 204. The first group index (u1) is calculated using equation (5),

$$u 1 = ( {f}_{g h} ( {n}_{s , f}^{μ} , {l}^{′} ) + {n}_{ID}^{SRS} ) mod 30 \qquad ( 5 )$$

The UE 102 may determine a second group index (u2) of the ZC sequence for the second group of antenna ports, at step 206. The second group index (u2) may be determined based on a group shift (n_{groupshift}) provided by the BS 104. In one implementation, the BS 104 may provide the group shift (n_{groupshift}) through higher layer signaling, such as Radio Resource Control (RRC). In case the BS 104 does not provide the group shift (n_{groupshift}) to the UE 102, the UE 102 may assume a default integer value for the group shift (n_{groupshift}). The second group index (u2) is calculated using equation (6),

$$u 2 = ( u 1 + {n}_{groupshift} ) mod 30 \qquad ( 6 )$$

The UE 102 may further determine a cyclic shift a; for each antenna port of the first group of antenna ports, at step 208. The cyclic shift a; is calculated using equations (7) and (8),

$${α}_{i} = 2 π \frac{{n}_{SRS}^{cs , i}}{{n}_{SRS}^{cs , max}} \qquad ( 7 )$$

$${n}_{SRS}^{c s , i} = ( {n}_{SRS}^{c s} + \frac{{n}_{SRS}^{cs , max} ( {p}_{i} - 1000 )}{{N}_{ap}^{SRS}} ) mod {n}_{SRS}^{cs , max} \qquad ( 8 )$$

where i ranges from 0 to (N̅ₐ̅ₚ̅^̅{̅S̅R̅S̅}̅−1).

The UE 102 may determine a cyclic shift aᵢ for each antenna port of the second group of antenna ports, at step 210. The cyclic shift a; is calculated using equations (9) and (10),

$${α}_{i} = 2 π \frac{{n}_{SRS}^{cs , i}}{{n}_{SRS}^{cs , max}} \qquad ( 9 )$$

$${n}_{SRS}^{c s , i} = ( {n}_{SRS}^{c s} + \frac{{n}_{SRS}^{cs , max} ( {p}_{i} - 1000 - {N}_{ap}^{\overline{SRS}} )}{( {N}_{ap}^{SRS} - {N}_{ap}^{\overline{SRS}} )} ) mod {n}_{SRS}^{cs , max} \qquad ( 10 )$$

where i ranges from 0 to (N̅ₐ̅ₚ̅^̅{̅S̅R̅S̅}̅ −1).

The ZC sequence may be mapped to physical resources for transmission of the SRS to the BS 104, at step 212. Thus, the UE 102 may maintain orthogonality between the first set of antenna ports and the second set of antenna ports by using different group index.

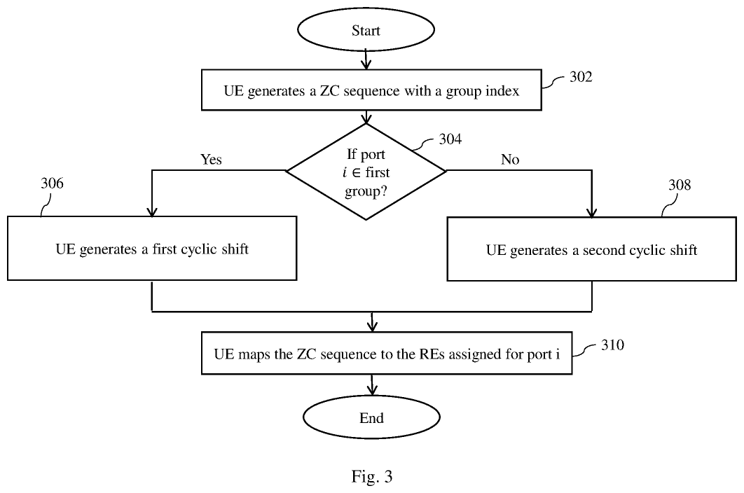

FIG. 3 illustrates a flow chart of a first method for transmission of the SRS to the BS 104 using a cyclic shift, in accordance with an embodiment of the present invention. The UE 102 may determine a common group index (u) of the ZC sequence for the first group of antenna ports and the second group of antenna ports based on slot and symbol index, at step 302. The common group index (u) is calculated using equation (5) as described above.

The UE 102 may check whether an antenna port belongs to the first group of antenna ports or not, at step 304. The UE 102 may determine a first set of cyclic shifts of the ZC sequence for the first group of antenna ports, at step 306. The first set of cyclic shifts may be equally spaced or uniformly distributed. The first set of cyclic shifts may be determined based on n_{SRs}^{CS} provided by the BS 104. The first set of cyclic shifts are calculated using equation (9) as described above.

The UE 102 may determine a second set of cyclic shifts of the ZC sequence for the second group of antenna ports at step 308. The second set of cyclic shifts may be equally spaced or uniformly distributed. The second set of cyclic shifts may be determined based on an offset value cs_{shift} from the first set of cyclic shifts. The second set of cyclic shifts are calculated using equations (11) and (12),

$${α}_{i} = 2 π \frac{{n}_{SRS}^{cs , i}}{{n}_{SRS}^{cs , max}} \qquad ( 11 )$$

$${n}_{SRS}^{cs , i} = \{ \begin{matrix}( {n}_{SRS}^{c s} + \frac{{n}_{SRS}^{cs , max} ( {p}_{i} - 1 \; 000 )}{- {N}_{ap}^{\overline{SRS}}} ) mod {n}_{SRS}^{cs , max} , if {p}_{i} < ( 1000 + {N}_{ap}^{\overline{SRS}} ) \\ ( {n}_{SRS}^{c s} + {cs}_{shift} + \frac{{n}_{SRS}^{cs , max} ( {p}_{i} - 1000 - {N}_{ap}^{\overline{SRS}} )}{( {N}_{ap}^{SRS} - {N}_{ap}^{\overline{SRS}} )} ) mod {n}_{SRS}^{cs , max} , otherwise\end{matrix} \qquad ( 12 )$$

The ZC sequence may be mapped to physical resources for transmission of the SRS to the BS 104, at step 310. Thus, the UE 102 may maintain orthogonality between the first set of antenna ports and the second set of antenna ports by using different cyclic shift.

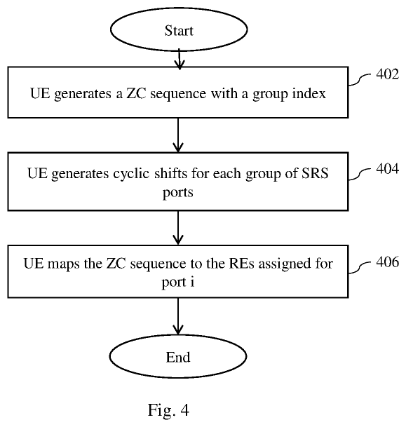

FIG. 4 illustrates a flow chart of a second method for transmission of SRS to the BS 102 using a cyclic shift, in accordance with an embodiment of the present invention. The UE 102 may determine a common group index (u) of the ZC sequence for the first group of antenna ports and the second group of antenna ports based on slot and symbol index, at step 402. The common group index (u) is calculated using equation (5) as described above.

The UE 102 may determine cyclic shifts of the ZC sequence for the first group of antenna ports and the second group of antenna ports, at step 404. The cyclic shifts may be equally spaced or uniformly distributed. The cyclic shifts are calculated using equations (13), (14), (15), and (16),

$${α}_{i} = 2 π \frac{{n}_{SRS}^{cs , i}}{{n}_{SRS}^{cs , max}} \qquad ( 13 )$$

$${n}_{SRS}^{cs , i} = ( {n}_{SRS}^{c s} + ⌊ \frac{{n}_{SRS}^{cs , max}}{{N}_{ap}^{SRS}} ⌋ ( {p}_{i} - 1000 ) ) mod {n}_{SRS}^{cs , max} \qquad ( 14 )$$

$${n}_{SRS}^{cs , i} = ( {n}_{SRS}^{c s} + ⌊ \frac{{n}_{SRS}^{cs , max}}{{N}_{ap}^{SRS}} ( {p}_{i} - 10 \; 00 ) ⌋ ) mod {n}_{SRS}^{cs , max} \qquad ( 15 )$$

$${n}_{SRS}^{cs , i} = ( {n}_{SRS}^{c s} + ⌈ \frac{{n}_{SRS}^{cs , max}}{{N}_{ap}^{SRS}} ( {p}_{i} - 1000 ) ⌉ ) mod {n}_{SRS}^{cs , max} \qquad ( 16 )$$

Where CS_{shift} is configured for the UE 102 by the BS 104 using higher layer signaling.
CS_{shift} ∈{1,2}, for example, if n_{SRS}^{cs,max}=12, CS_{shift}=1 if n_{SRS}^{cs,max}=8.
If CS_{shift} is not configured by the BS 104, the UE 102 assumes a default value.

The ZC sequence may be mapped to physical resources for transmission of SRS to the BS 104, at step 406. Thus, the UE 102 may maintain orthogonality between the first set of antenna ports and the second set of antenna ports by using different cyclic shift.

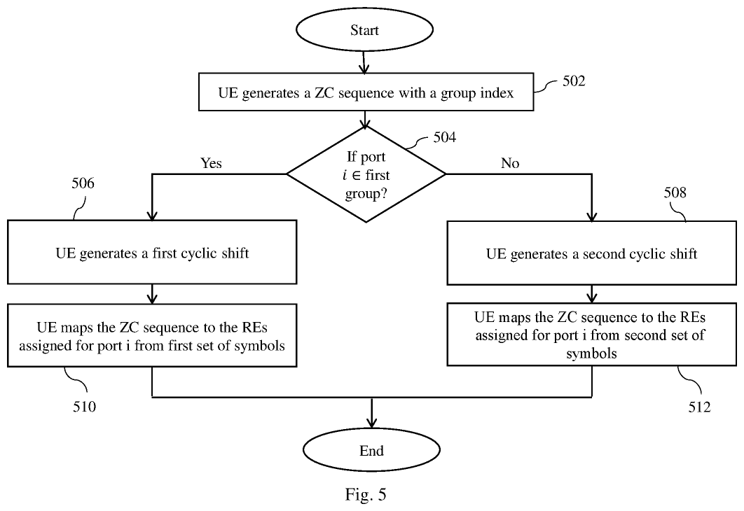

FIG. 5 illustrates a flow chart of a method for transmission of SRS to the BS 104 using symbols, in accordance with an embodiment of the present invention. The UE 102 may transmit the first group of antenna ports and the second group of antenna ports using Time Division Multiplexing (TDM) in different Orthogonal Frequency-Division Multiplexing (OFDM) symbols. The UE 102 may determine a common group index (u) of the ZC sequence for the first group of antenna ports and the second group of antenna ports based on slot and symbol index, at step 502. The common group index (u) is calculated using equation (5) as described above.

The UE 102 may check whether an antenna port belongs to the first group of antenna ports or not, at step 504. The UE 102 may determine a first cyclic shift of the ZC sequence for each antenna port of the first group of antenna ports, at step 506. The cyclic shift is calculated using equations (7) and (8) as described above.

The UE 102 may determine a second cyclic shift for each antenna port of the second group of antenna ports, at step 508. The cyclic shift is calculated using equations (9) and (10) as described above.

The UE 102 may obtain details about total number of symbols configured for transmission of SRS to the BS 104. In one implementation, the details about total number of symbols configured for transmission of SRS may be provided by the BS 104 through higher layer signaling, such as RRC. The UE 102 may divide the total number of symbols into a first set of symbols and a second set of symbols. In one implementation, the first set of symbols may be selected from alternate symbols from the total number of symbols, such as {0, 2, 4, . . . , 2*(N̅_̅{̅s̅y̅m̅b̅}̅^̅{̅S̅R̅S̅}̅−1)} and the second set of symbols may be selected from remaining symbols from the total number of symbols. In another implementation, the first set of symbols may be selected from consecutive symbols from the total number of symbols, such as {0,1, . . . , N_{symb}^{SRS}−1} and the second set of symbols may be selected from remaining symbols from the total number of symbols.

The UE 102 may map the ZC sequences for the first group of antenna ports with the first set of symbols, at step 510. The ZC sequences are mapped to the first group of antenna ports using equations (17-20),

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{p}}} {β}_{SRS} {r}^{( {p}_{i} )} ( {k}^{′} , {l}^{′} ) & {k}^{′} = 0 , 1 , … , {M}_{sc , b}^{SRS} - 1 \\ 0 & otherwise\end{matrix} \qquad ( 17 )$$

where l′ in the equation (17) takes all possible values from the first set of symbols.

The frequency-domain starting position k₀^{(Pi)} is defined by

$${k}_{0}^{( {p}_{i} )} = {\overline{k}}_{0}^{( {p}_{i} )} + {\sum }_{b = 0}^{{B}_{SRS}} {K}_{TC} {M}_{sc , b}^{SRS} {n}_{b} \qquad ( 18 )$$

$$where$$

$${\overline{k}}_{0}^{( {p}_{i} )} = {n}_{shift} {N}_{s c}^{R B} + ( {k}_{T C}^{( {p}_{i} )} + {k}_{offset}^{{l}^{′}} ) mod {K}_{T C} \qquad ( 19 )$$

$${k}_{T C}^{( {p}_{i} )} = \{ \begin{matrix}( {\overline{k}}_{T C} + {K}_{T C} / 2 ) mod {K}_{T C} & if {n}_{SRS}^{c s} ∈ \{ {n}_{SRS}^{cs , max} / 2 , … , {n}_{SRS}^{cs , max} - 1 \} and {N}_{ap}^{SRS} = 8 and {p}_{i} ∈ \{ 10 \; 01 , 1003 \} \\ {\overline{k}}_{T C} & otherwise\end{matrix} \qquad ( 20 )$$

Similarly, the UE 102 may map the ZC sequence for the second group of antenna ports with the second set of symbols, at step 512. The ZC sequences are mapped to the second group of antenna ports using equations (21-24),

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} - 1 \\ 0 & otherwise\end{matrix} \qquad ( 21 )$$

where l′ in the equation (21) may be assigned as possible values from the second set of symbols.

The frequency-domain starting position k₀^{(pi)} is defined by

$${k}_{0}^{( {p}_{i} )} = {\overline{k}}_{0}^{( {p}_{i} )} + {\sum }_{b = 0}^{{B}_{SRS}} {K}_{TC} {M}_{sc , b}^{SRS} {n}_{b} \qquad ( 22 )$$

$$where$$

$${\overline{k}}_{0}^{( {p}_{i} )} = {n}_{shift} {N}_{s c}^{R B} + ( {k}_{T C}^{( {p}_{i} )} + {k}_{offset}^{{l}^{′}} ) mod {K}_{T C} \qquad ( 23 )$$

$${k}_{T C}^{( {p}_{i} )} = \{ \begin{matrix}( {\overline{k}}_{T C} + {K}_{T C} / 2 ) mod {K}_{T C} & if {n}_{SRS}^{c s} ∈ \{ {n}_{SRS}^{cs , max} / 2 , … , {n}_{SRS}^{cs , max} - 1 \} and {N}_{ap}^{SRS} = 8 and {p}_{i} ∈ \{ 1005 , 1007 \} \\ {\overline{k}}_{T C} & otherwise\end{matrix} \qquad ( 24 )$$

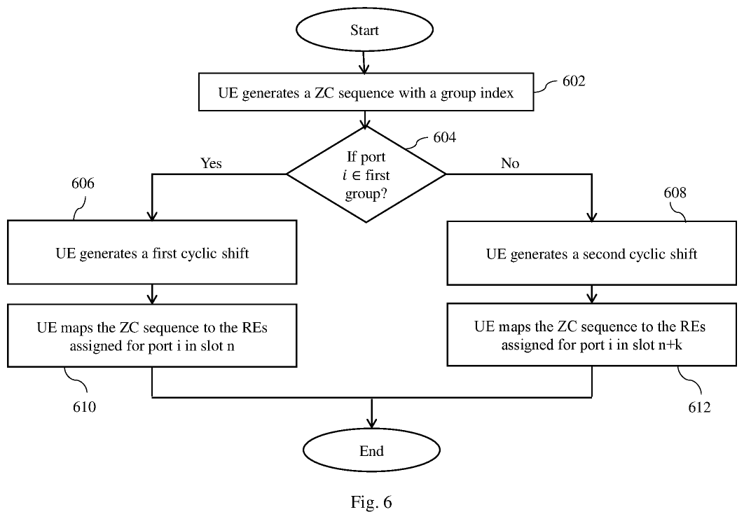

FIG. 6 illustrates a flow chart of a method for transmission of SRS to the BS 104 using time slots, in accordance with an embodiment of the present invention. The UE 102 may transmit the first group of antenna ports and the second group of antenna ports using TDM in different time slots. The UE 102 may determine a common group index (u) of the ZC sequence for the first group of antenna ports and the second group of antenna ports based on slot and symbol index, at step 602. The common group index (u) is calculated using equation (5) as described above.

The UE 102 may check whether an antenna port belongs to the first group of antenna ports or not, at step 604. The UE 102 may determine a first cyclic shift of the ZC sequence for each antenna port of the first group of antenna ports, at step 606. The cyclic shift is calculated using equations (7) and (8) as described above.

The UE 102 may determine a second cyclic shift for each antenna port of the second group of antenna ports, at step 608. The cyclic shift is calculated using equations (9) and (10) as described above.

The UE 102 may obtain details about time slots (n) configured for transmission of SRS to the BS 104. In one implementation, the details about time slots (n) configured for transmission of SRS may be provided by the BS 104 through higher layer signaling, such as RRC. The UE 102 may configure to transmit the SRS through the first group of antenna ports in time slot (n). Further, the UE 102 may configure to transmit the SRS through the second group of antenna ports in time slot (n+k). Where k is a slot offset determined using one of a pre-configured value at the UE 102 using the higher layer signaling, as a next SRS transmission occasion, as a next uplink slot, and as a predefined value.

The UE 102 may map the ZC sequences for the first group of antenna ports with the time slot (n), at step 610. The ZC sequences are mapped to the first group of antenna ports using equations (17-20) as described above.

Similarly, the UE 102 may map the ZC sequences for the second group of antenna ports with the time slot (n), at step 612. The ZC sequences are mapped to the second group of antenna ports using equations (21-24) as described above.

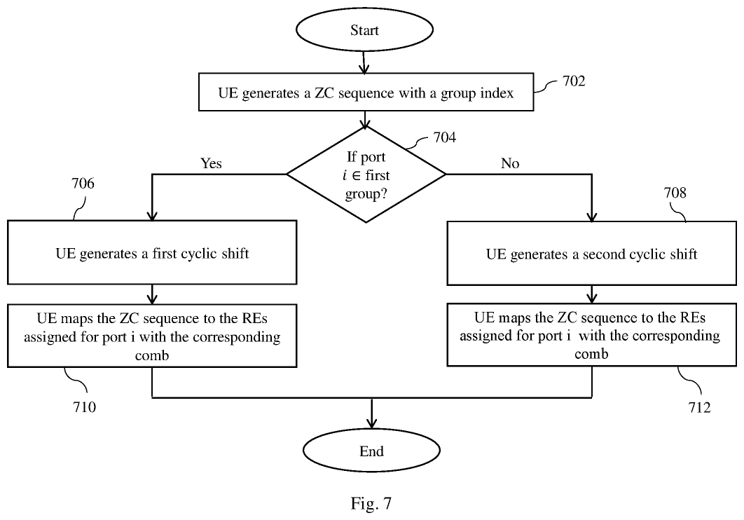

FIG. 7 illustrates a flow chart of a method for transmission of SRS to the BS 104 using Frequency Division Multiplexing (FDM), in accordance with an embodiment of the present invention. The UE 102 may transmit the first group of antenna ports and the second group of antenna ports using FDM in different frequency domain resources. The UE 102 may determine a common group index (u) of the ZC sequence for the first group of antenna ports and the second group of antenna ports based on slot and symbol index, at step 602. The common group index (u) is calculated using equation (5) as described above.

The UE 102 may check whether an antenna port belongs to the first group of antenna ports or not, at step 704. The UE 102 may determine a first cyclic shift of the ZC sequence for each antenna port of the first group of antenna ports, at step 706. The cyclic shift is calculated using equations (7) and (8) as described above.

The UE 102 may determine a second cyclic shift for each antenna port of the second group of antenna ports, at step 708. The cyclic shift is calculated using equations (9) and (10) as described above.

The UE 102 may map the ZC sequences for the first group of antenna ports, at step 710. The ZC sequences are mapped to the first group of antenna ports using equations (25-28),

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} - 1 \\ 0 & otherwise\end{matrix} \qquad ( 25 )$$

where l′ in the equation (25) takes all possible values from the set {0,1, . . . , N_{symb}^{SRS}−1} in the slot n.

The frequency-domain starting position k₀^{(Pi)} is defined by equation (26),

$${k}_{0}^{( {p}_{i} )} = {\overline{k}}_{0}^{( {p}_{i} )} + {\sum }_{b = 0}^{{B}_{SRS}} {K}_{TC} {M}_{sc , b}^{SRS} {n}_{b} \qquad ( 26 )$$

$$where$$

$${\overline{k}}_{0}^{( {p}_{i} )} = {n}_{shift} {N}_{s c}^{R B} + ( {k}_{T C}^{( {p}_{i} )} + {k}_{offset}^{{l}^{′}} ) mod {K}_{T C} \qquad ( 27 )$$

$${k}_{T C}^{( {p}_{i} )} = \{ \begin{matrix}( {\overline{k}}_{T C} + {K}_{T C} / 2 ) mod {K}_{T C} & if {n}_{SRS}^{c s} ∈ \{ {n}_{SRS}^{cs , max} / 2 , … , {n}_{SRS}^{cs , max} - 1 \} and {N}_{ap}^{SRS} \geq 4 and {p}_{i} ∈ \{ 1001 , 1003 \} \\ {\overline{k}}_{T C} & otherwise\end{matrix} \qquad ( 28 )$$

Similarly, the UE 102 may map the ZC sequences for the second group of antenna ports, at step 712. The ZC sequences are mapped to the second group of antenna ports using equations (29 . . . ),

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} - 1 \\ 0 & otherwise\end{matrix} \qquad ( 29 )$$

where l′ in the above equation takes all possible values from the set {0,1, . . . , N_{symb}^{SRS}−1} in the slot n+k.

$${k}_{0}^{( {p}_{i} )} = {\overline{k}}_{0}^{( {p}_{i} )} + {\sum }_{b = 0}^{{B}_{SRS}} {K}_{TC} {M}_{sc , b}^{SRS} {n}_{b} \qquad ( 30 )$$

$${\overline{k}}_{0}^{( {p}_{i} )} = {n}_{shift} {N}_{s c}^{R B} + ( {k}_{T C}^{( {p}_{i} )} + {k}_{offset}^{{l}^{′}} ) mod {K}_{T C} \qquad ( 31 )$$

$${k}_{T C}^{( {p}_{i} )} = \{ \begin{matrix}( {\overline{k}}_{T C} + ⌊ i / {N}_{ap}^{\overline{SRS}} ⌋ + {K}_{T C} / 2 ) mod {K}_{T C} & if {K}_{TC} = 4 , {n}_{SRS}^{c s} ∈ \{ {n}_{SRS}^{cs , max} / 2 , … , {n}_{SRS}^{cs , max} - 1 \} and {N}_{ap}^{SRS} = 8 and {p}_{i} ∈ \{ 1005 , 1007 \} \\ ( {\overline{k}}_{T C} + ⌊ i / {N}_{ap}^{\overline{SRS}} ⌋ ) mod {K}_{TC} & otherwise\end{matrix}$$

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method for communication between a user equipment and a base station, the method comprising:
determining Sounding Reference Signal antenna ports of a user equipment configured for transmission of sounding reference signals to a base station;
dividing the antenna ports into a first group of antenna ports and a second group of antenna ports when a number of antenna ports is greater than a predefined number of antenna ports;
determining a first set of parameters associated with the first group of antenna ports and a second set of parameters associated with the second group of antenna ports, for generation and transmission of the sounding reference signals, wherein orthogonality is maintained between the sounding reference signals of the first group of antenna ports and the sounding reference signals of the second group of antenna ports using one of a group index, a cyclic shift, and time division multiplexing;
generating, by the user equipment, a first set of sounding reference signals using the first set of parameters and a second set of sounding reference signals using the second set of parameters; and
transmitting, by the user equipment to the base station, the first set of sounding reference signals over the first group of antenna ports using the first set of parameters and the second set of sounding reference signals over the second group of antenna ports using the second set of parameters.

2. The method as claimed in claim 1, wherein the first set of parameters and the second set of parameters comprise group index, sequence index, cyclic shift of Zadoff-Chu sequences, OFDM symbol and, slot index.

3. The method as claimed in claim 1, wherein the first set of parameters are determined using a first group index and the second set of are determined using a second group index.

4. The method as claimed in claim 3, wherein the second group index is determined by addition of the first group index and a group shift provided by the base station.

5. The method as claimed in claim 1, wherein the first set of parameters are determined using a first set of cyclic shifts and the second set of parameters are determined using a second set of cyclic shifts.

6. The method as claimed in claim 5, wherein the second set of cyclic shifts are determined using the first set of cyclic shifts and an offset value of cyclic shift provided by the base station.

7. The method as claimed in claim 1, wherein the first set of parameters are determined using a first set of OFDM symbols and the second set of parameters are determined using a second set of OFDM symbols.

8. The method as claimed in claim 1, wherein the first set of parameters are determined using a first time slot and the second set of parameters are determined using a second time slot.

9. The method as claimed in claim 8, wherein the second time slot is determined by addition of the first time slot and a slot offset provided by the base station.

10. (canceled)
